(19) United States
(12) Patent Application Publication
(10) Pub. No.: US 2009/0164718 A1
(43) Pub. Date: Jun. 25, 2009

(54) DISK ARRAY DEVICE CONTROL METHOD

(75) Inventor: Tatsuhiko USHIKI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/332,466

(22) Filed: Dec. 11, 2008

(30) Foreign Application Priority Data
Dec. 21, 2007 (JP) 2007-330731

(51) Int. Cl. G06F 12/00; G06F 12/16

(52) U.S. Cl. 711/112; 711/161; 711/E12.001

(57) ABSTRACT

A method for controlling a disk array device connected to an management server for managing the disk array device, the disk array device having priority information indicating priority of transmission on the basis of type of log data, the method includes: storing log data of the disk array device, transmitting to the management server a request for checking information of amount of log data receivable by the management server, receiving from the management server information of amount of log data receivable by the management server, selecting data from the log data on the basis of the information of the of amount of log data receivable by the management server and the priority information, and transmitting the selected data to the management server.

### CROSS-REFERENCE TO RELATED APPLICATION

This application is based upon and claims the benefit of priority of the prior Japanese Patent Application No. 2007-330731, filed on Dec. 21, 2007, the entire contents of which are incorporated herein by reference.

### FIELD

An aspect of the invention relates to a method for controlling a disk array device.

### BACKGROUND

In general, upon receiving and transmitting data without fails between information processing devices connected communicably, the information processing device on the transmission side does not unilaterally transmit the data but should send the data so that the information processing device on the reception side receives and stores the data without fail in consideration of the capacity of a storage device for reception in the information processing device on the reception side.

As disclosed in Japanese Laid-open Patent Publication No. 2006-067116, there is proposed a data processing method of an information processing system, in which, before transmitting image data created by reading an image with an image processing device from the image processing device to a host computer via a network, data compressing processing changes the amount of image data by a user, thereby transmitting the image data with a desired amount of data of the user to the host computer.

Also as disclosed in Japanese Laid-open Patent Publication No. 9-023326, there is a facsimile communication method in which, a facsimile device on the transmission side receives a notification indicating a free capacity of a receiving memory from a facsimile device on the reception side before transmitting image data from the facsimile device on the transmission side to the facsimile device on the reception side via a communication line, the amount of the image data is compared with a free capacity of the receiving memory, if the free capacity of the receiving memory is not less than the amount of the image data, general transmission is performed, if the free capacity of the receiving memory is less than the amount of the image data, and the image data is subjected to compressing processing and is then transmitted.

Further, as disclosed in Japanese Laid-open Patent Publication No. 2001-251563, there is proposed a program-information transmitting device that transmits the amount of transmission packets of program information per unit time in order of the priority upon transmitting the program information from the program-information transmitting device to a receiving device via a network so as to keep a reference value of the amount of transmission packets, thereby preventing the overflow of a receiving buffer in the receiving device.

With all the conventional arts, the information processing device on the reception side can receive data without fail by limiting data to be transmitted from the information processing device on the transmission side in accordance with a state of resources of a storage device in the information processing device on the reception side.

However, the typical conventional arts disclosed in Japanese Laid-open Patent Publication Nos. 2006-067116 and 9-023326 have the following problem. That is, the information processing device has a structure that can record various types of logs (error log, event log, and operation log) for operating the information processing device in many cases. The various types of logs (various log) are analyzed and are used for finding out a default reason occurring in the information processing device.

Further, there is such a remote management system upon connecting a large number of the information processing devices via a network, that a management server collects various log data from the information processing devices and individually manages the information processing devices. In the remote management system, in order to limit the capacity of a storage device in the management server, the amount of transmission data for one time from the information processing device to a management server is generally restricted.

Since the amount of data in various logs received by the remote management system is enormous, even by applying the conventional arts disclosed in Japanese Laid-open Patent Publication Nos. 2006-067116 and 9-023326, all log data cannot be efficiently received and transmitted without fail from a plurality of information processing devices to the management server.

Incidentally, even by applying the conventional art disclosed in Japanese Laid-open Patent Publication No. 2001-251563 to the remote management system, the conventional art represented by Japanese Laid-open Patent Publication No. 2001-251563 limits the amount of transmission data per unit time. Therefore, when the amount of data in the log is enormous, the reception and transmission of the log data can be delayed.

### SUMMARY

According to an aspect of an embodiment, a method for controlling a disk array device connected to an management server for managing the disk array device, the disk array device having priority information indicating priority of transmission on the basis of type of log data, the method includes: storing log data of the disk array device, transmitting to the management server a request for checking information of amount of log data receivable by the management server, receiving from the management server information of amount of log data receivable by the management server, selecting data from the log data on the basis of the information of the of amount of log data receivable by the management server and the priority information, and transmitting the selected data to the management server.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A, FIG. 1B, FIG. 1C, FIG. 1D, FIG. 1E, and FIG. 1F are diagrams for explaining the outline of process of the embodiment;

FIG. 2 is a block diagram illustrating the structure of an RAID device according to the embodiment;

FIG. 3 is a diagram illustrating an example of log data;

FIG. 4 is a block diagram illustrating the structure of RoC according to the embodiment;

FIG. 5 is a diagram illustrating an example of a pattern selecting table;

FIG. 6 is a diagram illustrating an example of a priority determining table;

FIG. 7 is a flowchart illustrating a routine for processing for transmitting log data;

FIG. 8 is a flowchart illustrating a routine for priority determining processing;

FIG. 9A and FIG. 9B are diagrams illustrating the outline of processing raising the priority of non-transmitted log data;

FIG. 10A and FIG. 10B are diagrams illustrating the outline of processing for adding the past non-transmitted log data and transmitting the log data;

FIG. 11A and FIG. 11B are diagrams illustrating the outline of processing for adding information indicating there is non-transmitted log data and transmitting log data;

FIG. 12A and FIG. 12B are diagrams illustrating the outline of processing for adding log ID of non-transmitted log data and transmitting the log data; and

FIG. 13 is a functional block diagram illustrating the structure of a remote management server 300;

FIG. 14 is a diagram illustrating an example of a table for storing received log data;

FIG. 15 is a diagram illustrating an example of a table for storing ID of non-transmitted log;

FIG. 16 is a diagram illustrating an example of a table for determining the maximal amount of transmission data;

FIG. 17 is a flowchart illustrating a routine for processing for transmitting the maximal amount of transmission log data; and

FIG. 18 is a flowchart illustrating a routine for processing upon receiving log data.

### DESCRIPTION OF EMBODIMENTS

Hereinbelow, a description will be given of a disk-array-device management system, a disk array device, a control method of the disk array device, and a management server with reference to the drawings according to an embodiment. The disk array device allows a plurality of magnetic disk devices to have a redundant structure and also allows data stored in a magnetic disk to be made redundant, and further prevents the erasure of storage data because of the default of a magnetic disk device.

Hereinbelow, a disk array device will be described as an information processing device with a structure for recording a log, for transmitting the recorded log to the management server according to the embodiment. However, the invention is not limited to this and, in general, the information processing device that records the log and transmits the recorded log to the management server can be widely applied.

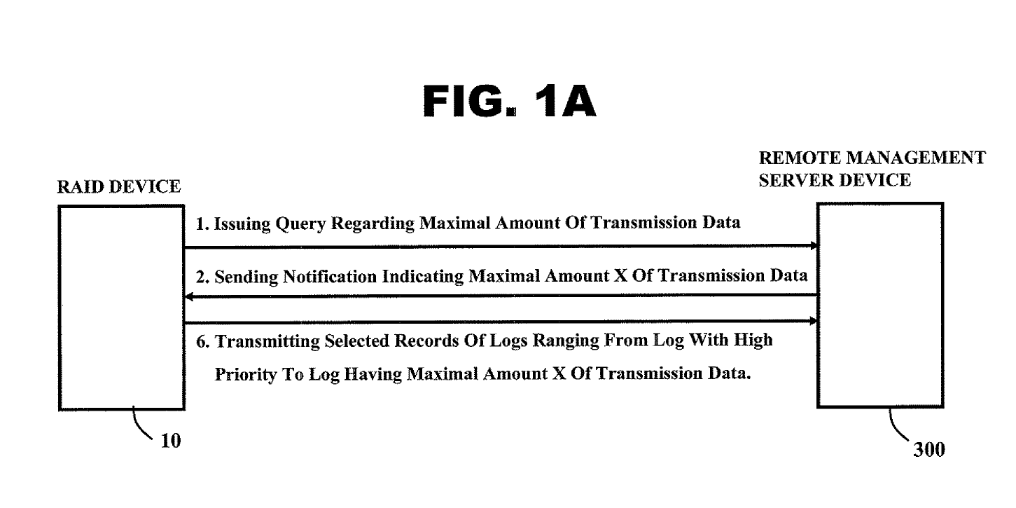

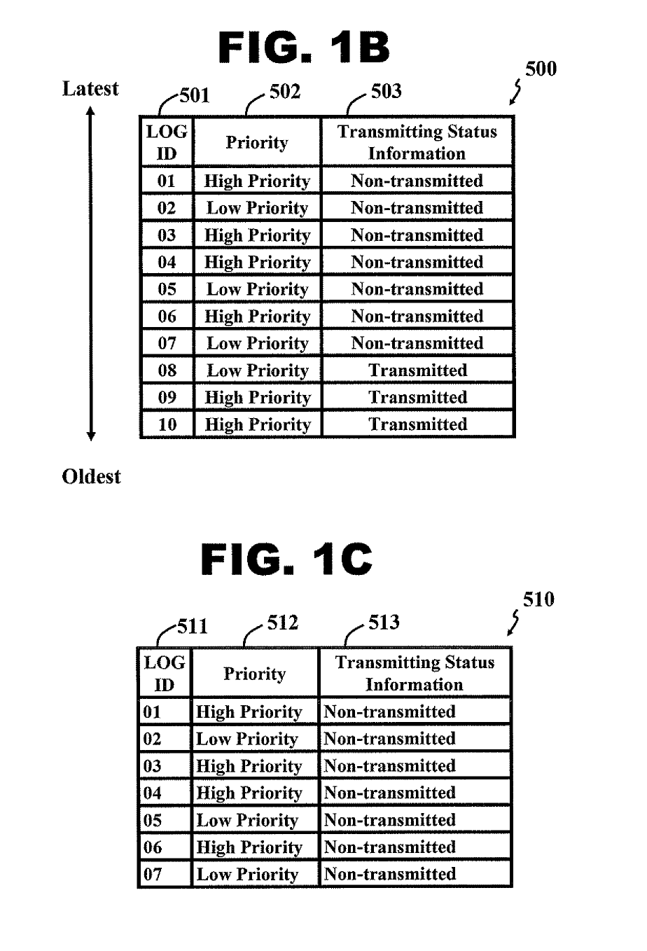

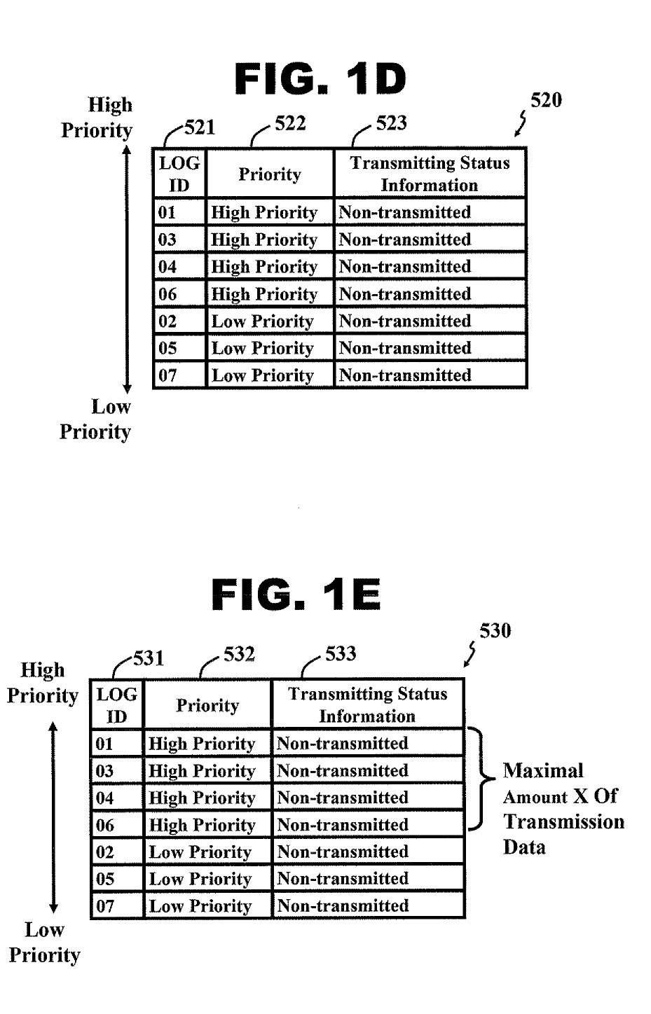

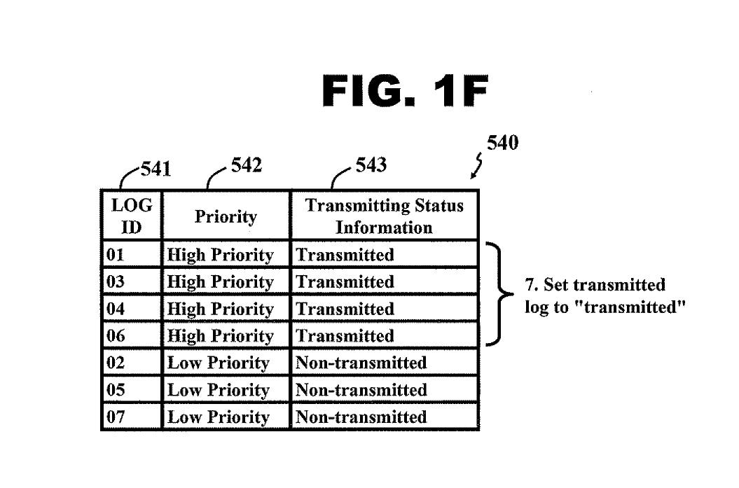

First of all, a description will be given of the outline according to an aspect of the embodiment. FIG. 1A, FIG. 1B, FIG. 1C, FIG. 1D, FIG. 1E, and FIG. 1F are a diagram for explaining the outline of the embodiment. Referring to FIG. 1A, a disk array device 10 (hereinafter, referred to as a Redundant Arrays of Inexpensive Disks (RAID) device) and, a management server 300 (hereinafter, referred to as a remote management server 300) are connected to be communicable via a network.

Incidentally, the RAID device 10 records logs including at least ‘log ID’ for uniquely identifying log data recorded every time for causing various events such as a default in the device, ‘priority information’ of the log data, and ‘transmitting status information’ indicating whether or not the log data is transmitted to the remote management server 300, see FIG. 1B. The log data 500 of FIG. 1B has log ID 501, priority information 502, and transmitting status information 503. The disk array device transmits the log data to the remote management server 300 in accordance with a predetermined schedule.

A storage device that stores the log data transmitted from the RAID device 10 is connected to the remote management server 300 or is included therein. The remote management server 300 stores the log data transmitted from the RAID device 10 to the storage device. The remote management server 300 remotely manages the RAID device 10 on the basis of the log transmitted from the RAID device 10.

(1) The RAID device 10 issues a query indicating the maximal amount of data (hereinafter, referred to as the maximal amount of transmission data) of the log data which the remote management server 300 can receive from the RAID device 10, to the remote management server 300.

(2) Subsequently, the remote management server 300 sends a notification indicating the maximal amount of transmission data (X [Mbyte]) corresponding to the resource situation in the device to the RAID device 10 in response to a query of the maximal amount of transmission data from the PAID device 10.

(3) Subsequently, the RAID device 10 that receives the maximal amount (X [Mbyte]) of transmission data extracts a record in a transmitting status indicating “non-transmitted” from all log data recorded in the RAID device, see FIG. 1C. The log data 510 of FIG. 1C is extracted from the log data 500 of FIG. 1B. The log ID 511, the priority information 512, and the transmitting status information 513 of FIG. 1C corresponds the log ID 501, the priority information 502, and the transmitting status information 503 of FIG. 1B respectively.

(4) Subsequently, the PAID device 10 sorts the extracted record of the log having ‘transmitting status information’ indicating the “non-transmitted” on the basis of the ‘priority information’ in order of higher priority, see FIG. 1D. The log data 520 of FIG. 1D is selected from the log data 510 of FIG. 1B. The log ID 521, the priority information 522, and the transmitting status information 523 of FIG. 1D corresponds the log ID 511, the priority information 512, and the transmitting status information 513 of FIG. 1C respectively.

(5) Subsequently, the RAID device 10 selects the RAID device 10 selects records of the logs within a range of the maximal amount of transmission data (X[Mbyte]) in the order of descending priorities, among the sorted records of the logs having the ‘transmitting status information’ indicating the “non-transmitted” with higher priority, see FIG. 1E. The log data 530 of FIG. 1E is selected from the log data 520 of FIG. 1D. The log ID 531, the priority information 532, and the transmitting status information 533 of FIG. 1E corresponds the log ID 521, the priority information 522, and the transmitting status information 523 of FIG. 1D respectively.

(6) Subsequently, the RAID device 10 transmits the selected records of the logs within a range of the maximal amount of transmission data (X[Mbyte]) in the order of descending priorities to the remote management server 300, see FIG. 1F. The log data 540 of FIG. 1F is selected from the log data 530 of FIG. 1E. The log ID 541, the priority information 542, and the transmitting status information 543 of FIG. 1F corresponds the log ID 531, the priority information 532, and the transmitting status information 533 of FIG. 1E respectively.

(7) Subsequently, the RAID device 10 sets the ‘transmitting status information’ of the record of the log transmitted to the remote management server 300 to “transmitted”.

As mentioned above, the RAID device 10 checks in advance the amount of data that can be received by the remote management server 300, selects the log data that can be included in the amount of data in order of priority, and transmits the selected log data to the remote management server 300, thereby preventing the excess of the capacity of the storage device in the remote management server 300. Further, since important log data can be preferentially received and stored to the remote management server 300, the log data can be efficiently transmitted.

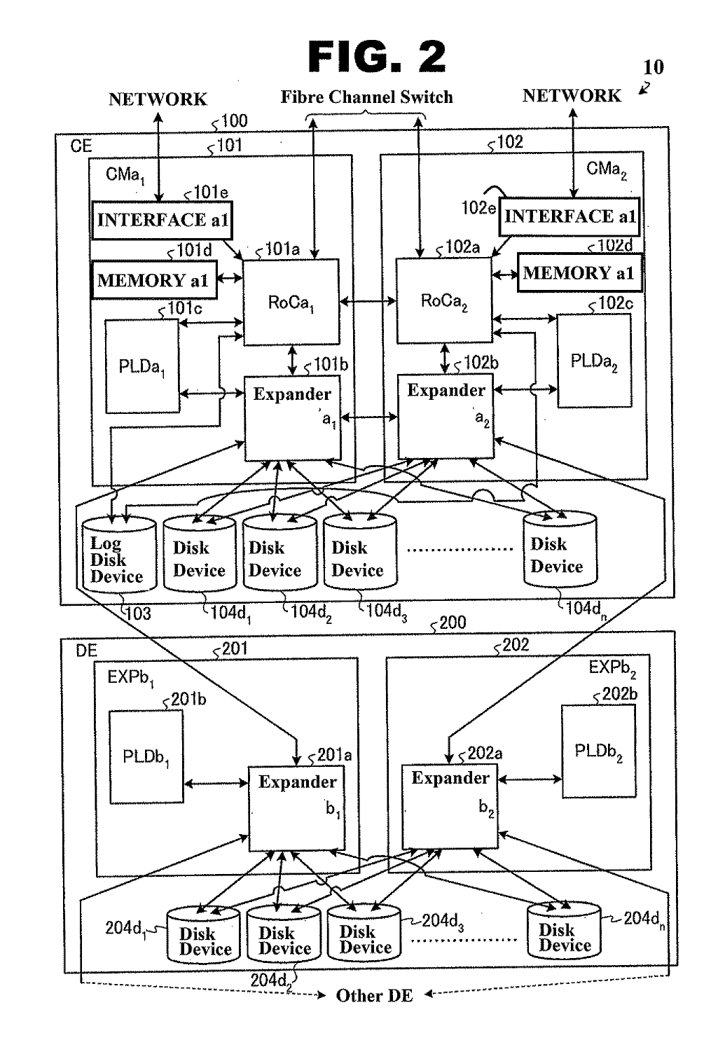

Next, a description will be given of the structure of the RAID device 10 according to the embodiment. FIG. 2 is a block diagram illustrating the structure of the RAID device 10 according to the aspect of the embodiment. Referring to FIG. 2, an RAID device 10 according to the aspect of the embodiment is formed into a controller enclosure (CE) 100 and a device enclosure (DE) 200 by dividing casings. The controller enclosure (CE) 100 mainly has units for controlling the RAID device 10 and a communication module among the RAID device 10, a host computer device, and the remote management server 300. The device enclosure (DE) 200 has a disk device.

The CE 100 is connected to the host computer device, via a channel adaptor (not shown), through a fibre channel as an external device, and is further connected to the DE 200 via a device adaptor (not shown). Herein, the channel adaptor means an adaptor on the channel side, and the device adaptor means an adaptor on the device side.

The CE 100 includes at least two controller modules (CMs) for controlling the operation of the RAID device 10 (CMa₁ 101 and CMa₂ 102 according to the aspect of the embodiment), ensuring the redundancy. Further, the DE 200 is connected to a plurality of the CEs 100, directly to the device adaptor or via a router.

The CE 100 includes not only the CMa₁ 101 and the CMa₂ 102 but also a log disk device 103 to which various logs (various types of log data) are written in response to instructions from the CMa₁ 101 or the CMa₂ 102 and disk devices 104d₁, . . . , 104dₙ to/from which the CMa₁ 101 and the CMa₂ 102 write/read data with redundancy. The log disk device 103 is a magnetic disk device or may be any storage device having a storage medium for storing a large amount of data. Incidentally, although not shown, the CE 100 has a plurality of power units.

The CMa₁ 101 includes: an raid-on-chip (RoC)a₁ 101a as a CPU having an RAID engine for controlling the RAID device; an expander a₁101b corresponding to the device adaptor; a programmable logic device (PLD) a₁101c including various logical circuits necessary for controlling the CMa₁ 101; a memory a₁101d; and an interface a₁101e for connection to the remote management server 300, such as networks including a local area network (LAN), which will be described later. The elements are mutually connected to enable reception and transmission of data.

Similarly, the CMa₂ 102 includes: the RoC a₂102a; the expander a₂102b; a PLD a₂102c; a memory a₂102d; and an interface a₂102e for connection to a network such as LAN, and the elements are mutually connected to enable reception and transmission of data. Further, the reception and transmission of data can be performed so as to keep the cooperation of redundant elements between the RoC a₁101a and the RoC a₂102a and between the expander a₁101b and the expander a₂102b.

The RoC a₁101 and the RoC a₂102a are individually connected to the log disk device 103. The RoC a₁101a and the RoC a₂102a respectively write logs of various events of the disk device occurring in the CE 100 or DE 200 to the storage medium of the log disk device 103, extracts the log written to the log disk device 103, and transmits the extracted log to the remote management server 300 via the interface a₁101e or the interface a₂102e.

Incidentally, any of the RoC a₁101a and the RoC a₂102a is operated as a main system and the other is operated as a sub-system for writing the log to the log disk device 103. According to the aspect of the embodiment, the RoC a₁101a functions as a main system and the RoC a₂102a functions as a sub-system for the process for writing the log.

The RoC a₁101a and the RoC a₂102a mutually monitor the overlap of logs so as not to overlappingly write the logs based on the same events by the RoC a₁101a and the RoC a₂102a before writing the log. If the logs are overlapped, the operation is controlled so that only the RoC a₁101a as a main system writes the log.

Further, the RoC a₁101a functions as an operation system and the RoC a₂102a functions as a waiting system for processing for transmitting the log data stored in the log disk device 103 from the CE 100 to the remote management server 300. That is, the RoC a₁101a performs process for transmitting the log data from the CE 100 to the remote management server 300. When the RoC a₁101a does not normally function because of a default, the RoC a₂102a performs the process instead of the RoC a₁101a. The disk devices 104d₁, . . . , 104dₙ are connected to an expander a₁101b and an expander a₂102b. Further, the expander a₁101b and the expander a₂102b are independently connected to the DE 200.

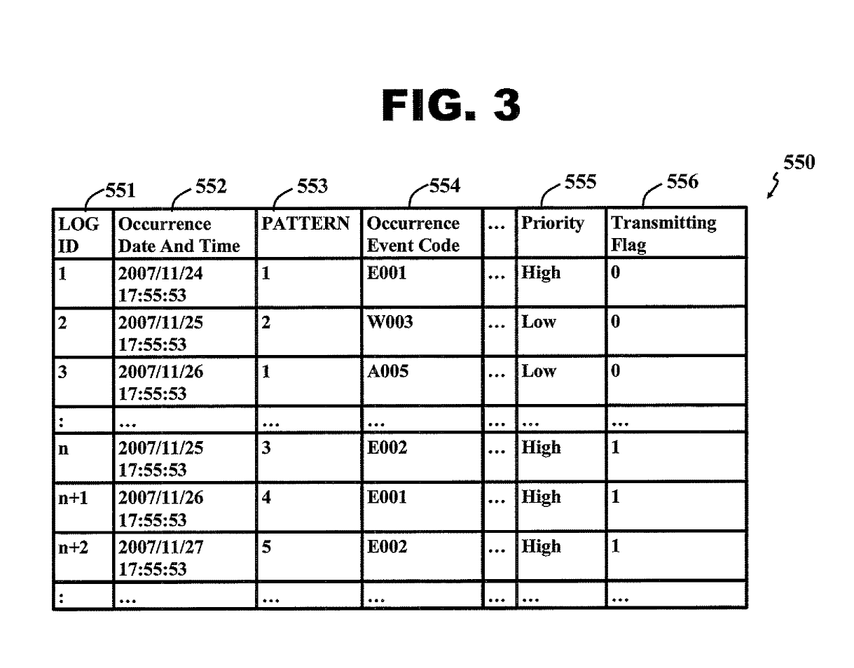

The log disk device 103 is a storage device that can store the log data. FIG. 3 shows an example of the log data table 550.

The log data table 550 records the log data. The log data includes items of at least ‘log ID’ 551 , ‘occurrence date and time’ 552, ‘pattern’ 553, ‘occurrence event code’ 554, ‘priority’ 555, and ‘transmission flag’ 556.

The ‘log ID’ 551 is identification information for uniquely identifying the log data. The ‘occurrence date and time’ 552 indicates the date and time when an event to which the log data is written occured. The ‘pattern’ 553 is information indicating the pattern of the event to which the log data is written. The ‘occurrence event code’ 554 is information indicating contents of the occurrence event, indicated by code.

The ‘priority’ 555 indicates the degree of importance and the degree of emergency of the event in the log data, and is information indicating the level of priority to be transmitted to the remote management server 300. To the ‘transmission flag’ 556, a flag ‘1’ is set if the log data is transmitted, and a flag ‘0’ is set if the log data is not transmitted. As a consequence, it can be determined whether or not the log data is transmitted to the remote management server 300.

The DE 200 includes disk devices 204d₁, . . . , 204dₙ and at least two EXPs (Expander Modules) (EXP b₁201 and EXP b₂202 according to the aspect of the embodiment) for controlling the writing/reading of data with the disk devices, ensuring the redundancy. Incidentally, although not shown, the DE 200 has a plurality of power units.

The disk devices 204d₁, . . . , 204dₙ are connected to an expander b₁201a and an expander b₂202a. Further, the expander b₁201a and the expander b₂202a are independently connected to the expander a₁101b and the expander a₂102b. Furthermore, the expander b₁201a and the expander b₂202a can be connected to anther DE.

The EXP b₁201 includes: the expander b₁201a as a device adaptor to the disk devices 204d₁, . . . , 204dₙ; and the PLD b₁201b including various logical circuits necessary for controlling the EXP b₁201. The expander b₁201a and the PLD b₁201b are mutually connected to enable reception and transmission of data.

The expander b₁201a is connected to the expander a₁101b in the CE 100 to enable mutual reception and transmission of data. That is, the expander b₁201a receives the data written to the disk devices 204d₁, . . . , 204dₙ from the expander a₁101b, and transmits the data read from the disk devices 204d₁, . . . , 204dₙ to the expander a₁101b.

Further, the expander b₁201a sends a notification indicating various events occurring in the disk devices 204d₁, . . . , 204dₙ to the RoC a₁101a via the expander a₁101b.

Similarly, the EXP b₂202 includes: the expander b₂202a as the device adaptor to the disk devices 204d₁, . . . , 204dₙ; and the PLD b₂202b including various logical circuits necessary for controlling the EXP b₂202. The expander b₂202a and the PLD b₂202b are connected thereto to enable mutual reception and transmission of data.

The expander b₂202a is connected to the expander a₂102b in the CE 100 to enable mutual reception and transmission of data. That is, the expander b₂202a receives the data written to the disk devices 204d₁, . . . , 204dₙ from the expander a₂102b and transmits the data read from the disk devices 204d₁, . . . , 204dₙ to the expander a₂102b.

Further, the expander b₂202a sends a notification indicating various events occurring in the disk devices 204d₁, . . . , 204dₙ to the RoC a₂102a via the expander a₂102b.

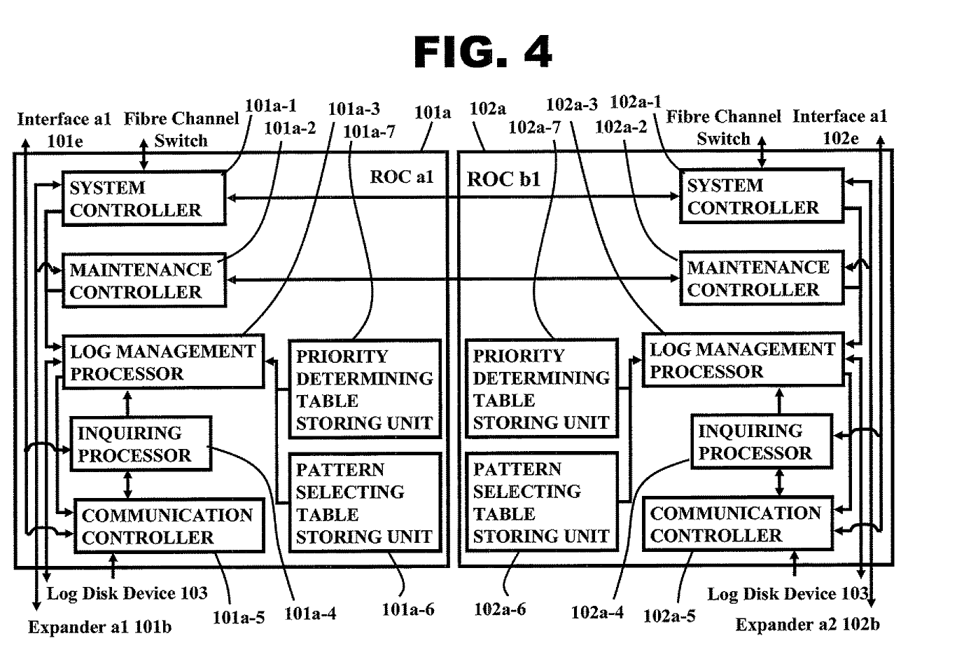

Next, a description will be given of the structure of the RoC a₁101a and the RoC a₂102a shown in FIG. 2. FIG. 4 is a block diagram illustrating the structure of the RoC according to the aspect of the embodiment. Incidentally, since the RoC a₁101a and the RoC a₂102a have the same structure, the RoC a₁101a will be mainly described.

The RoC a₁101a includes: a system controller 101a-1; a maintenance controller 101a-2; a log management processor 101a-3; an inquiring processor 101a-4 of the maximal amount of transmission data; a communication controller 101a-5; a pattern selecting table storing unit 101a-6; and a priority determining table storing unit 101a-7.

Further, the RoC a₂102a includes: a system controller 102a-1; a maintenance controller 102a-2; a log management processor 102a-3; an inquiring processor 102a-4 of the maximal amount of transmission data; a communication controller 102a-5; a pattern selecting table storing unit 102a-6; and a priority determining table storing unit 102a-7. Reference numerals are different only between the RoC a₁101a and the RoC a₂102a and the same reference numeral denotes the same component.

The system controller 101a-1 is a controller that performs power control, RAID control, reliability, availability, serviceability (RAS) control, activation maintenance, structure management, and system monitoring of the RAID device 10. Further, the system controller 101a-1 is connected to an external fibre channel switch via a channel adaptor (not shown) so as to enable mutual reception and transmission of data. Further, the maintenance controller 101a-2 is a controller that performs various maintenance controls of the RAID device 10.

Incidentally, the system controller 101a-1 and the maintenance controller 101a-2 are connected to the expander a₁101b so as to enable mutual reception and transmission of data. Further, the system controller 101a-1 and the maintenance controller 101a-2 are connected to the system controller 102a-1 and the maintenance controller 102a-2 in the RoC a₂102a to enable the reception and transmission of data for the purpose of keeping the cooperation of the redundant structure.

The log management processor 101a-3 determines a pattern corresponding to the occurrence event from the system controller 101a-1 or the maintenance controller 101a-2 in response to a log writing request caused by the event such as a default by referring to the pattern selecting table 560 in the pattern selecting table storing unit 101a-6. Then, the log management processor 101a-3 determines the priority of the log in accordance with the pattern by referring to the priority determining table 570 in the priority determining table storing unit 101a-7, and thereafter writes the log data to the log disk device 103. The log management processor 101a-3 functions as an obtaining module for obtaining log data of the disk array device or a selecting module for extracting data from the log data on the basis of the information of the amount of the log data receivable and the priority information.

Further, the log management processor 101a-3 reads only a ‘predetermined amount of data’ of the latest log data and higher priority from the log disk device 103 in accordance with a predetermined schedule. The log management processor 101a-3 performs process for transmitting the log data to the remote management server 300 via the communication controller 101a-5 and the interface a₁101e.

Incidentally, the ‘predetermined amount of data’ is information as a result of the inquiry by the inquiring processor 101a-4 of the maximal amount of transmission data to the remote management server 300. Prior to the transmission of the log data to the remote management server 300, the inquiring processor 101a-4 of the maximal amount of transmission data inquires the maximal amount of data of the log data that may be transmitted to the remote management server 300 to the remote management server 300 via the communication controller 101a-5 and the interface a₁101e. The inquiring processor 101a-4 functions as a checking module for transmitting a request for checking information of amount of the log data receivable by the management server to the management server.

The communication controller 101a-5 functions as a receiving module for receiving the information of amount from the management server or a transmitting module for transmitting the extracted data to the management server.

In response to the inquiry, the remote management server 300 transmits the maximal amount of data of the log data that may be transmitted to the remote management server 300 by the RAID device 10 as the ‘predetermined amount of data’ to the RAID device 10 on the basis of the free capacity of resources in the storage unit in the device, date and time, and the number of the RAID devices 10 as a management target. Incidentally, the ‘predetermined amount of data’ may have a fixed value.

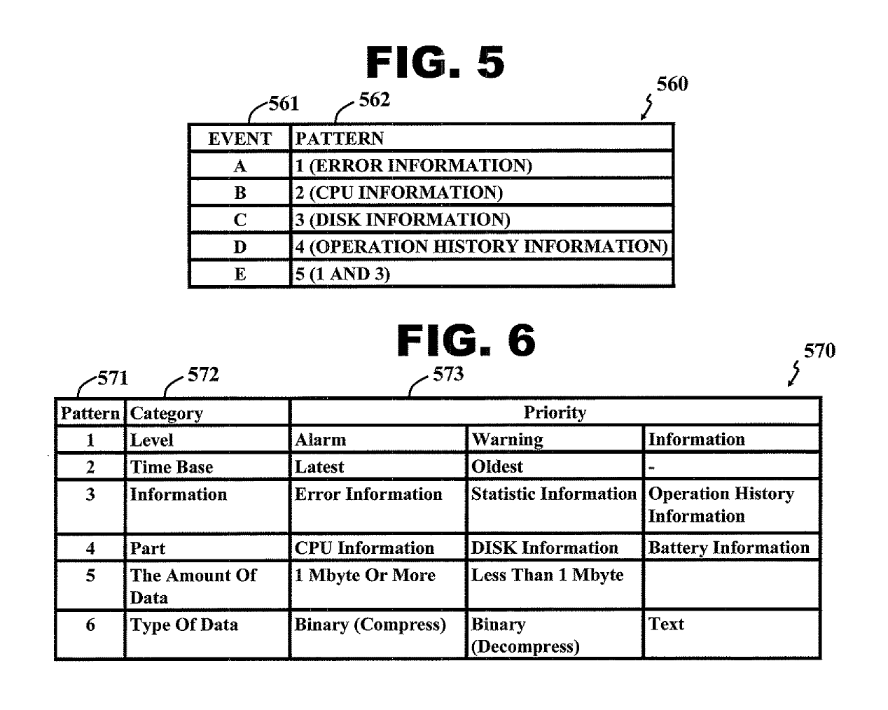

The pattern selecting table storing unit 101a-6 is a storage unit that can store a pattern selecting table 560. As shown in FIG. 5, the pattern selecting table 560 has columns of the ‘event’ 561 and the ‘pattern’ 562. The ‘event’ 561 is information for identifying the event caused in the RAID device 10. The ‘pattern’ 562 is information indicating contents of the ‘event’ 561.

As shown in the pattern selecting table 560 in FIG. 5, if the ‘event’ 561 is an “event A”, the ‘pattern’ 562 is a “pattern 1 (error information)”. That is, obviously, the ‘event’ 561 caused in the RAID device 10 is “error information of the pattern 1”.

The pattern selecting table 560 has a correspondence between the pattern including a keyword and the event in advance, and is a table for determining the priority for transmitting the log data having the same pattern as the pattern corresponding to the event each time when the event is caused in the RAID device 10. Incidentally, a default pattern is set as the ‘pattern 1’.

The priority determining table storing unit 101a-7 is a storage unit that can store a priority determining table 570. As shown in the priority determining table 570 in FIG. 6, the priority determining table 570 has columns of the ‘pattern’ 571 ‘category’ 572 , and ‘priority’ 573.

The ‘pattern’ 571 corresponds to the ‘event’ 561 selected by referring to the pattern selecting table 560. The ‘category’ 572 is information indicating contents of the ‘pattern’ 573.

The ‘priority’ 573 has item values varied depending on the ‘pattern’ 573 and the ‘category’ 572 and as the item value is close to the left in the item of the ‘priority’ 573, the priority is higher.

If the ‘pattern’ 571 and the ‘category’ 572 are “pattern 1” and “level”, the “error information” is any of “Alarm”, “Warning”, and “Information”. Incidentally, a relation of the priority is established as “Alarm”>“Warning”>“Information”.

If the selected ‘pattern’ 571 by referring to the pattern selecting table 560 is the “pattern 1 (error information)”, the ‘category’ 572 determined by referring to the priority determining table 570 on the basis of the “pattern 1 (error information)” is the “level” and the ‘Priority’ is then determined depending on “Alarm”, “Warning”, and “Information” indicating the “level” of the “error information”.

For example, according to the aspect of the embodiment, the following values are given to items value of the ‘priority’. Then, as the value of the ‘priority’ is larger, the priority is higher. That is, “3” is given to “Alarm” as the ‘priority’ at the ‘level’ of the “pattern 1” as the ‘priority’, “2” is given to “Warning”, and “1” is given to “Information”.

Further, “2” is given to “the latest” ‘priority’ on ‘time base’ of “pattern 2” as the ‘pattern’, and “1” is given to “the oldest” ‘priority’. Then, “3” is given to the “error information” indicated by the ‘priority’ of the “pattern 3” as the ‘pattern’. Further, “2” is given to “statistic information” and “1” is given to “operation history information”

Further, “3” is given to “CPU information” indicated by the ‘priority’ ‘every part’ of “pattern 4” as the ‘pattern’. Then, “2” is given to “DISK information”, and “1” is given to “battery information”. Further, “2” is given to “1 Mbyte or more” indicated by the ‘priority’ of ‘the amount of data’ of “pattern 5” as the ‘pattern’, and “1” is given to “less than 1 Mbyte”. Furthermore, “3” is given to “binary (compress)” indicated by the ‘priority’ of the ‘type of data’ of the log data of “pattern 6” as the ‘pattern’, “2” is given to “binary (decompress)”, and “1” is given to “text”.

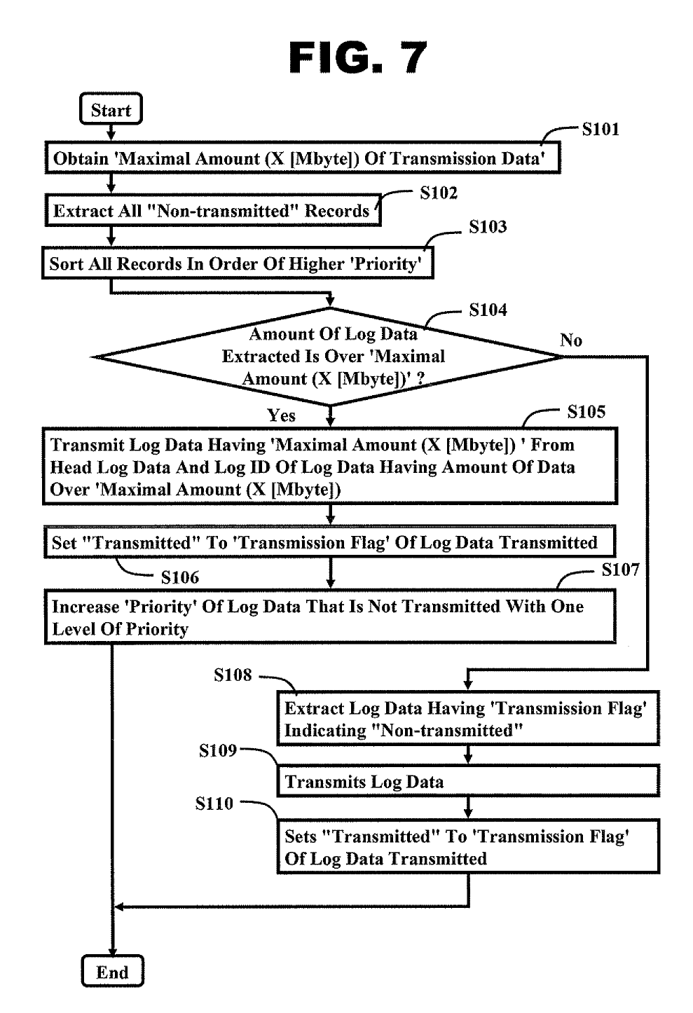

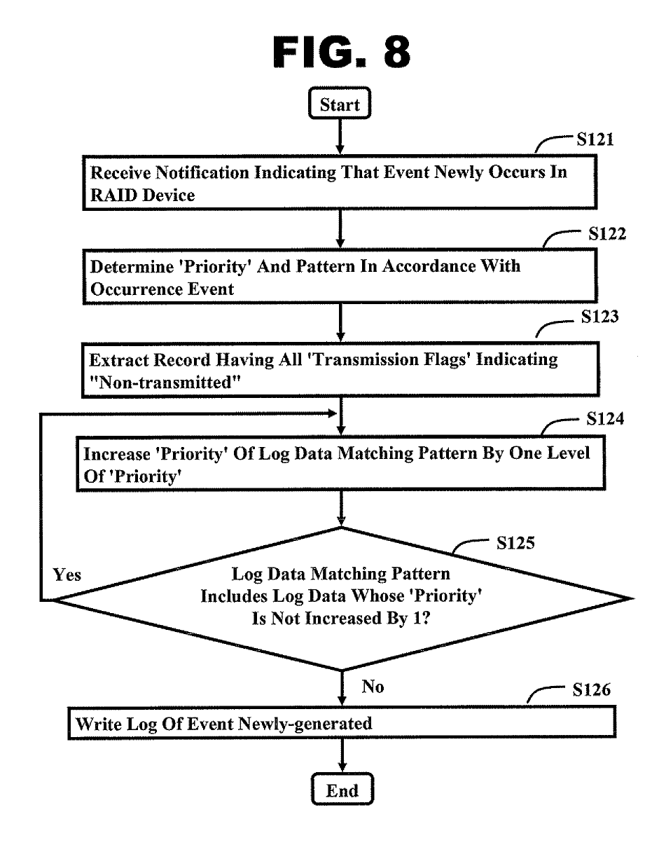

Incidentally, “1” is cumulatively added to values of the ‘priority’ by processing in step S107 in FIG. 7 or step S124 in FIG. 8, as will be described later. Therefore, the values of the ‘priority’ can be over those given to the item values of the ‘priority’. However, as the value of the ‘priority’ is larger, the priority is higher. Therefore, the log data can be preferentially transmitted to the remote management server 300 with high possibility.

Next, a description will be given of process for transmitting the log data executed by the RoC (RoC a₁101a and the RoC a₂102a) shown in FIGS. 2 and 4. FIG. 7 is a flowchart illustrating a routine of the process for transmitting the log data. Incidentally, the process is executed by the RoC a₁101a as the RoC of the operation system. If a default is caused in the RoC a₁101a, the RC a₂102a as the RC of the waiting system executes the processing, instead of the RoC a₁101a.

Referring to FIG. 7, first of all, the inquiring processor 101a-4 of the maximal amount of transmission data is connected to the remote management server 300, and obtains ‘the maximal amount (X [Mbyte]) of transmission data’ of the log data that can be transmitted one time from the remote management server 300 (step S101). Incidentally, the inquiring processor 101a-4 of the maximal amount of transmission data sends a notification indicating the obtained ‘maximal amount (X [Mbyte]) of transmission data’ to the log management processor 101a-3.

Subsequently, the log management processor 101a-3 extracts records ranging from the record at the latest ‘occurrence date and time’ to the record having the ‘transmission flag’ indicating “1 (transmitted)” from among all log data stored in the log disk device 103 in the RAID device 10 (step S102), thereby extracting all “non-transmitted” records indicating no transmission to the remote management server 300.

Subsequently, the log management processor 101a-3 sorts all records of the log data extracted in step S102 in order of higher ‘priority’ (step S103). Subsequently, the log management processor 101a-3 determines whether or not the amount of the log data extracted in step S102 is over ‘the maximal amount (X [Mbyte]) of transmission data’ obtained in step S101 (step S104).

When it is determined that the amount of the log data extracted in step S102 is over ‘the maximal amount (X [Mbyte]) of transmission data’ obtained in step S101 (YES in step S104), the process shifts to step S105. If it is not determined that the amount of the log data extracted in step S102 is over ‘the maximal amount (X [Mbyte]) of transmission data’ obtained in step S101 (NO in step S104), the process shifts to step S108.

In step S105, the log management processor 101a-3 selects transmission log data having ‘the maximal amount (X [Mbyte]) of transmission data’ from the head log data sorted in step S103, adds the log ID of the log data having the amount of data over ‘the maximal amount (X [Mbyte]) of transmission data’ that is not set as the transmission log data to the transmission log data, and transmits the resultant data to the remote management server 300 (step S105).

Subsequently, the log management processor 101a-3 sets “1 (transmitted)” to the ‘transmission flag’ of the log data transmitted to the remote management server 300 in step S105 (step S106). Subsequently, the log management processor 101a-3 resets the ‘priority’ of the log data by increasing the ‘priority’ of the log data that is not transmitted to the remote management server 300 in step S105 with one level of the priority (specifically, adding “1” to the value of the ‘priority’ in step S107). The process ends and the process for transmitting the log data then ends.

In step S108, the log management processor 101a-3 extracts the log data that is not over ‘the maximal amount (X [Mbyte]) of transmission data’, having the ‘transmission flag’ indicating the “non-transmitted” from among the head log data stored in step S103, as the transmission log data. In the processing, the log data that was not transmitted at the past time is also extracted as the transmission log data.

Subsequently, the log management processor 101a-3 transmits the log data extracted in step S108 to the remote management server 300 (step S109). Subsequently, the log management processor 101a-3 sets “1 (transmitted)” to the ‘transmission flag’ of the log data transmitted to the remote management server 300 in step S109, similarly to step S106 (step S110). The process ends and the process for transmitting the log data then ends.

Next, a description will be given of priority determining process executed by the RoC (RoC a₁101a and RoC a₂102a) shown in FIGS. 2 and 4. FIG. 8 is a flowchart illustrating a routine of the priority determining processing.

Incidentally, the process is executed when the RoC a₁101a as the RoC of the main system and the RoC a₂102a as the RoC of the sub-system write the log to the log disk device 103.

When the RoC a₁101a and the RoC a₂102a write the log on the basis of the same event, only the RoC a₁101a of the main system executes the writing operation. Hereinbelow, a description will be given by assuming that the RoC a₁101a of the main system performs the priority determining processing. Further, when the RoC a₂102a of the sub-system performs the priority determining processing, the similar process is executed.

In the processing, the pattern including a keyword is correlated with the events in advance and the priority for transmitting the log data having the same pattern as the pattern corresponding to the event is determined every time when the event occurs in the RAID device 10. Incidentally, the default is set as the ‘pattern 1’.

First of all, the log management processor 101a-3 receives a notification indicating that the event newly occurs in the RAID device 10 from the system controller 101a-1 or the maintenance controller 101a-2 (step S121). Subsequently, the log management processor 101a-3 selects the ‘pattern’ in accordance with the occurrence event notified in step S121 by referring to the pattern selecting table 560 stored in the pattern selecting table storing unit 101a-6, and determines the ‘priority’ by referring to the priority determining table 570 stored in the priority determining table storing unit 101a-7 (step S122).

Subsequently, the log management processor 101a-3 extracts the record having all ‘transmission flags’ stored in the log disk device 103 indicating “0 (non-transmitted)” (step S123). Subsequently, the log management processor 101a-3 increases the ‘priority’ of the log data matching the pattern selected in step S122 by one level of the ‘priority’ (specifically, adding “1” to the value of the ‘priority’, in step S124).

Subsequently, the log management processor 101a-3 determines whether or not the log data matching the pattern selected in step S122 includes the log data whose ‘priority’ is not increased by 1 (step S125).

When it is determined that the log data matching the pattern selected in step S122 includes the log data whose ‘priority’ is not increased by 1 (YES in step S125), the process shifts to step S124. On the other hand, when it is not determined that the log data matching the pattern selected in step S122 includes the log data whose ‘priority’ is not increased by 1 (NO in step S125), the process shifts to step S126.

In step S126, the 109 management processor 101a-3 writes the log of the event newly-generated in step S121 to the log disk device 103. The process ends and the routine of the priority determining process then ends.

With the above processing, when the event (e.g., disk fault and change in setting of the network environment) occurs in the RAID device 10, by this chance, the ‘priority’ of the “non-transmitted” log data is reset.

If a disk fault is caused, the ‘priority’ of the non-transmitted log data in the disk fault and the error information is increased. Further, when the change in setting of the network environment occurs, the ‘priority’ of the non-transmitted log data in the operation history information is increased. As operated above, the transmission priority of the log data necessary for analyzing the reason of the event is dynamically changed on the remote management server side. Therefore, the log data with a high advantage to the analysis of the reason at the time can be preferentially transmitted to the remote management server.

Incidentally, by the chance of causing the event in the RAID device 10, all ‘priorities’ of the “non-transmitted” log data are not reset and are not increased. However, the ‘priority’ of only the “non-transmitted” log data based on the same event as the event occurring in the RAID device 10 may be increased. As a consequence thereof, the transmission priority of the log data concerning the newly-occurring event in the RAID device 10 can be increased and the log data assumed as completely important one can be transmitted to the remote management server without fail. The reason of the newly-occurring event can be early found out.

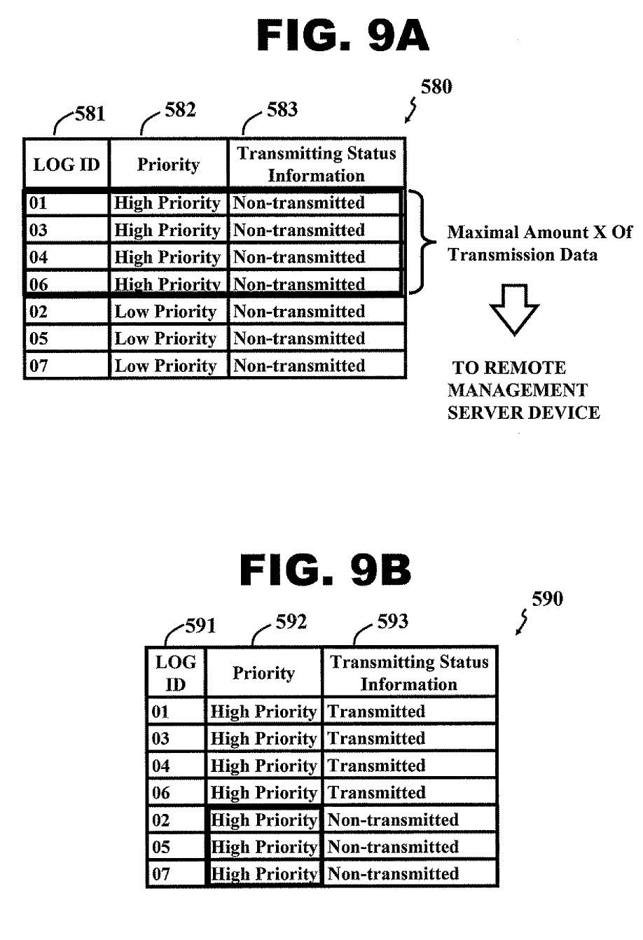

Next, a description will be given of the outline of process for increasing the priority of the non-transmitted log data. FIG. 9A and FIG. 9B are diagrams illustrating the outline of process for raising the priority of non-transmitted log data. The log data 580 of FIG. 9A shows before transmitting the log data to the management server. The log ID 581, the priority information 582, and the transmitting status information 583 of FIG. 9A corresponds the 109 ID 531, the priority information 532, and the transmitting status information 533 of FIG. 1E, respectively. The log data 590 of FIG. 9B shows after transmitting the log data to the management server. The log ID 591, the priority information 592, and the transmitting status information 593 of FIG. 9B corresponds the log ID 581, the priority information 582, and the transmitting status information 583 of FIG. 9A, respectively. Referring to FIG. 9A and FIG. 9B, as shown in step S105 in FIG. 7, the log management processor 101a-3 selects ‘the maximal amount (X [Mbyte]) of transmission data’, as the transmission log data, from the head log data stored in step S103 in FIG. 7, adds the log ID of the log data that has the amount of data over ‘the maximal amount (X [Mbyte]) of transmission data’ and is not as the transmission log data to the transmission log data, and transmits the resultant data to the remote management server 300.

As shown in step S106 in FIG. 7, the log management processor 101a-3 sets “1 (transmitted)” to the ‘transmission flag’ 593 of the log data transmitted to the remote management server 300. Subsequently, as shown in step S107 in FIG. 7, the log management processor 101a-3 increases the ‘priority’ 592 of the log data that is not transmitted to the remote management server 300 by 1 and resets the priority (from “low priority” to “higher priority”).

As mentioned above, the log data that is transmitted to the remote management server 300 and the log data that is not transmitted to the remote management server 300 can be identified. Further, the priority of the log data that is not transmitted to the remote management server 300 is increased and the resultant priority is preferentially transmitted at the next transmission time.

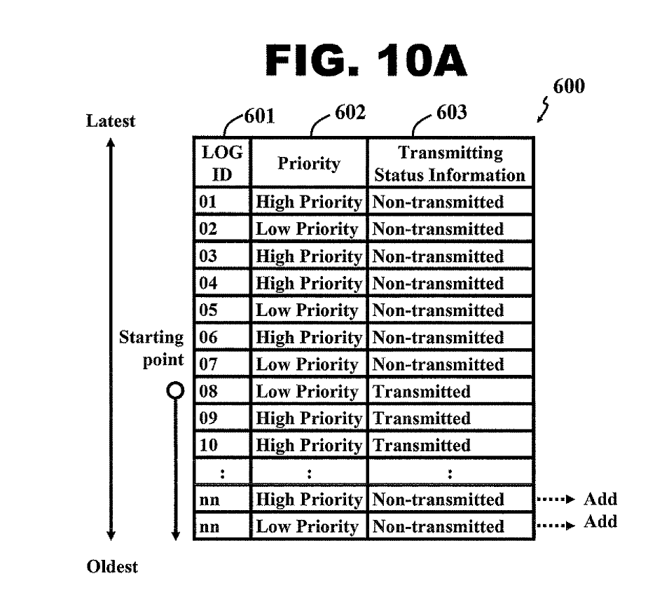

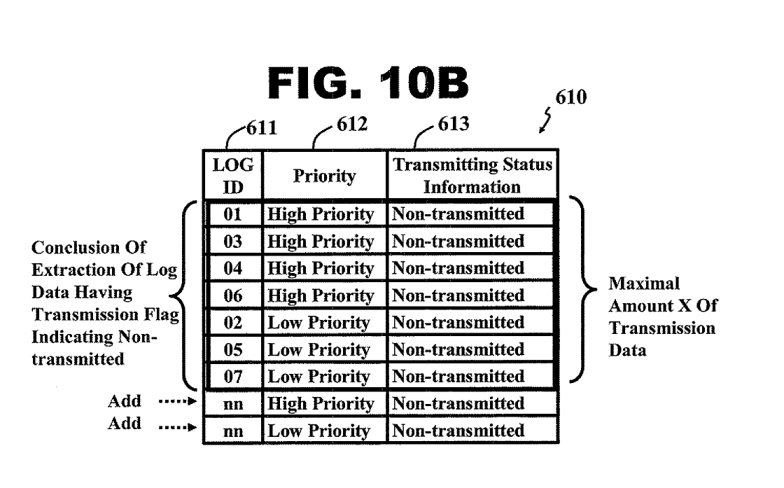

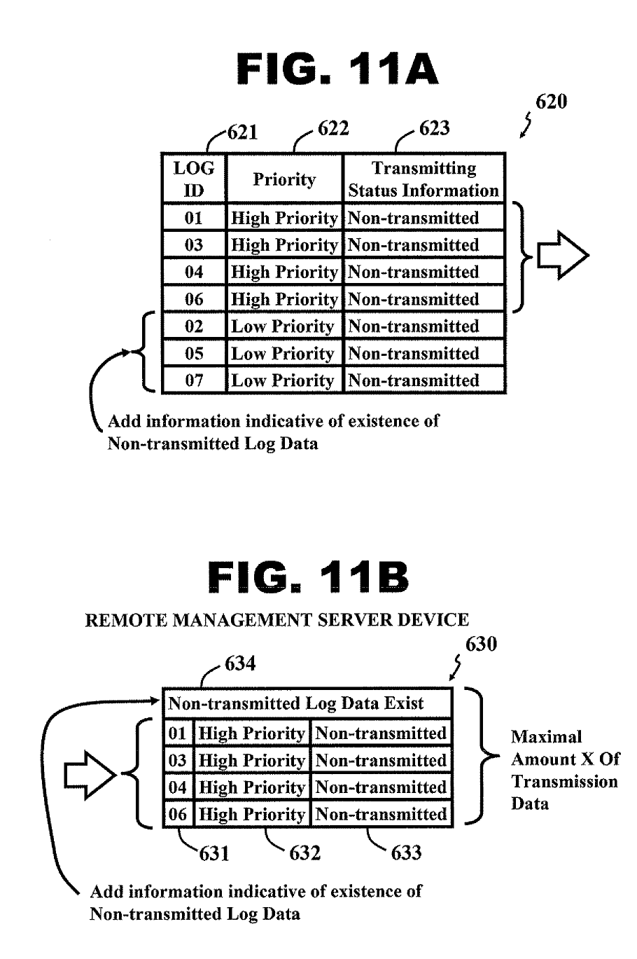

Next, a description will be given of the outline of process for adding the past non-transmitted log data and transmitting the resultant log data. FIG. 10A and FIG. 10B are diagrams illustrating the outline of the process for adding the past non-transmitted log data and transmitting the resultant log data. The log data 600 of FIG. 10A shows before transmitting the log data to the management server. The log ID 601, the priority information 602, and the transmitting status information 603 of FIG. 10A corresponds the log ID 501, the priority information 502, and the transmitting status information 503 of FIG. 11B, respectively. The log data 610 of FIG. 10B shows selected the log data from the log data 600. The log ID 611, the priority information 612, and the transmitting status information 613 of FIG. 10B corresponds the log ID 601, the priority information 602, and the transmitting status information 603 of FIG. 10A, respectively.

Referring to FIG. 10A and FIG. 10B, the log management processor 101a-3 extracts the log data having the ‘transmission flag’ indicating “non-transmitted” as the transmission log data that is not over ‘the maximal amount (X [Mbyte]) of data for transmission’ from the head log data sorted in step S103 in FIG. 7.

In the processing, the log data having ‘log IDs’ from “01” to “07” is extracted. Since the amount of the log data having the ‘log IDs’ from “01” to “07” is not over the maximal amount (X [Mbyte]) of data, the log management processor 101a-3 traces back the log data, starting from log data of “08” as a record next to the log data having the ‘log IDs’ from “01” to “07”, and adds, to the transmission log data, the log data having the ‘transmission flag’ indicating “0 (non-transmitted)” within the maximal amount (X) of data in order of the log data with newer and higher priority (refer to step S108 in FIG. 7).

As shown in step 5109 in FIG. 7, the log data having the maximal amount of data less than the maximal amount of data: (X [Mbyte]) is extracted as the transmission log data and the log management processor 101a-3 then transmits the transmission log data to the remote management server 300. With the processing, the log data that was not transmitted in the past is extracted as the transmission log data, and is transmitted to the remote management server 300.

Incidentally, upon transmitting the transmission log data to the remote management server 300, information indicating that there is the non-transmitted log data 634 may be added and the resultant log data 630 may be then transmitted. FIG. 11A and FIG. 11B are diagrams illustrating the outline of process for adding the information indicating there is the non-transmitted log data and transmitting the log data. The log data 620 of FIG. 11A shows before transmitting the log data to the management server. The log ID 621, the priority information 622, and the transmitting status information 623 of FIG. 11A corresponds the log ID 521, the priority information 522, and the transmitting status information 523 of FIG. 1D, respectively. The log data 630 of FIG. 11B shows transmitting data to the management server. The log ID 631, the priority information 632, and the transmitting status information 633 of FIG. 11B corresponds the log ID 621, the priority information 622, and the transmitting status information 623 of FIG. 11A, respectively.

Referring to FIG. 11A and FIG. 11B, when there is the log data having the ‘transmission flag’ indicating “0 (non-transmitted)” though the log data having the maximal amount (X [Mbyte]) of transmission data is extracted as the transmission log data, the log management processor 101a-3 may add information 634 indicating ‘non-transmitted log data: YES’ to the head or last transmission log data and may then transmit the resultant log data. As a consequence, the remote management server 300 side recognizes that there is the ‘non-transmitted log data’, and prompts manual transmission of the ‘non-transmitted log data’ to the RAID device 10 side.

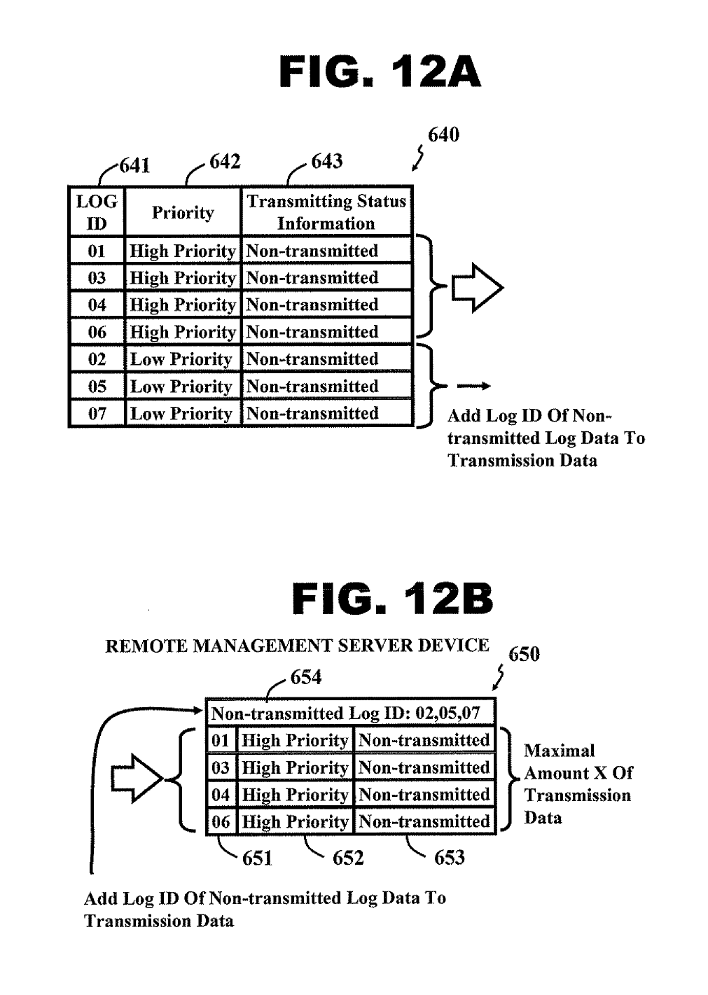

Further, upon transmitting the transmission log data to the remote management server 300, the ‘log ID’ of the non-transmitted log data may be added and the resultant log data may be then transmitted. FIG. 12A and FIG. 12B are diagrams illustrating the outline of process for adding the log ID of the non-transmitted log data and transmitting the log data. The log data 640 of FIG. 12A shows before transmitting the log data to the management server. The log ID 641, the priority information 642, and the transmitting status information 643 of FIG. 12A corresponds the log ID 521, the priority information 522, and the transmitting status information 523 of FIG. 1D, respectively. The log data 650 of FIG. 12B shows transmitting data to the management server. The log ID 651, the priority information 652, and the transmitting status information 653 of FIG. 12B corresponds the log ID 641, the priority information 642, and the transmitting status information 643 of FIG. 12A, respectively.

Referring to FIG. 12A and FIG. 12B, even if the log data having the maximal amount (X [Mbyte]) of transmission data is extracted as the transmission log data and the log data having the ‘transmission flag’ indicating “0 (non-transmitted)” exists yet, the log management processor 101a-3 may add the ‘log ID’ of the ‘non-transmitted log data’ to the head or final transmission log data and may then transmit the resultant log data. As a consequence, the remote management server 300 side recognizes the existence of the ‘non-transmitted log data’, and promotes the manual transmission of the ‘non-transmitted log data’ to the RAID device side. Further, upon thereafter transmitting the log data, the remote management server 300 side inspects whether or not the log data is dropped.

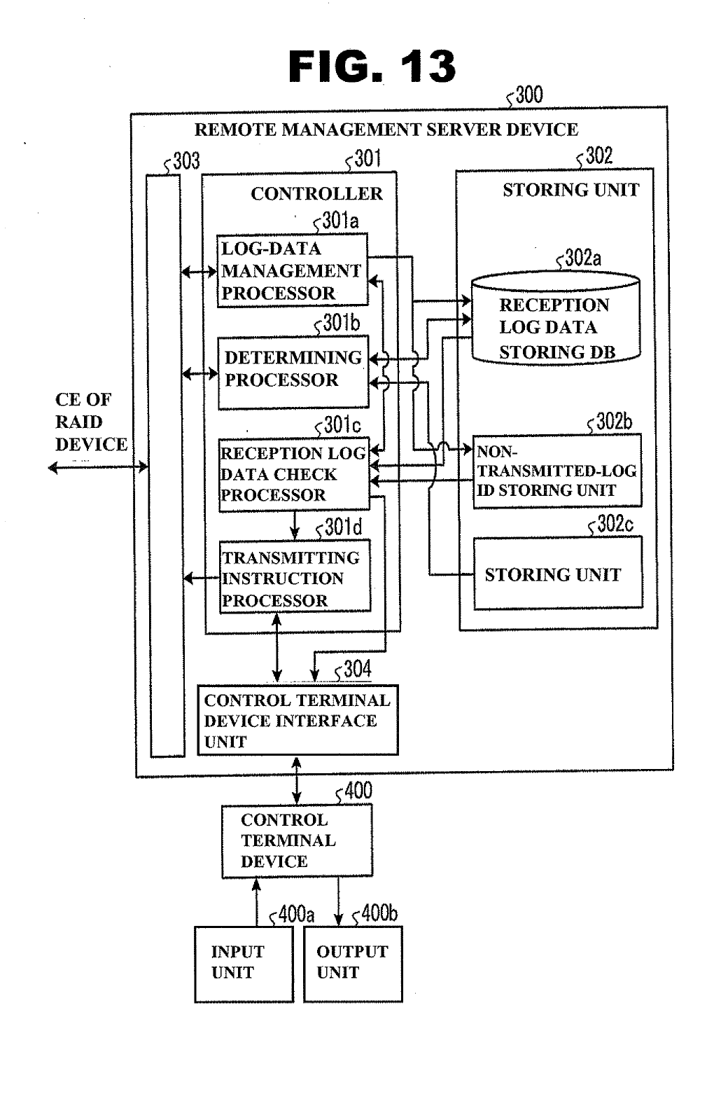

Next, a description will be given of the structure of the remote management server 300. FIG. 13 is a functional block diagram illustrating the structure of the remote management server 300. A remote management server 300 according to the aspect of the embodiment is connected to the CE 100 of the RAID device 10 to be mutually communicable therewith via a network such as LAN. The remote management server 300 remotely manages the RAID device 10 by collecting the log data from at least one RAID device 10.

Incidentally, according to the aspect of the embodiment, a plurality of the RAID devices 10 are connected to the remote management server 300, and the remote management server 300 remotely manages a plurality of the RAID devices 10 in accordance the predetermined schedule with by collecting the log data from the RAID devices 10.

A control terminal device 400 is connected to the remote management server 300. An input unit 400a such as a keyboard or mouse and an output unit 400b such as a display unit or printer unit are connected to the control terminal device 400. A manager of the RAID device 10 controls the monitoring of the remote management server 300 via the control terminal device 400 and operates the remote management server 300.

Referring to FIG. 13, the remote management server 300 includes: a controller 301; a storing unit 302; a communication interface unit 303 as a communication interface with the RAID device 10; and a control terminal device interface unit 304 as a connection interface with a control terminal device.

The controller 301 is a controller for totally controlling the remote management server 300, and includes: a log-data management processor 301a; a determining processor 301b of the maximal amount of transmission data; a reception log data check processor 301c; and a transmitting instruction processor 301d of non-transmitted log data with the structure according to the aspect of the embodiment.

The log-data management processor 301a stores the log data received from the RAID device 10 to a reception log data storing DB (DataBase) 302a, which will be described later. If the log ID of the non-transmitted log data is added to the received log data, a log-data management processor 301a recognizes that the non-transmitted log data exists, and stores the log ID to a non-transmitted-log ID storing unit 302b, which will be described later. The log-data management processor 301a functions as a log data receiving module for receiving the selected data from the disk array device.

Incidentally, if only information indicating ‘non-transmitted log data: YES’ is added to the received log data, the log-data management processor 301a recognizes only that the non-transmitted log data exists.

The determining processor 301b of the maximal amount of transmission data totally determines the free capacity of resources in the reception log data storing DB 302a, the reference result of the determining table of the maximal amount of transmission data at the current date and time in a storing unit 302c of the determining table of the maximal amount of transmission data, which will be described later, and the number of the RAID devices 10 and the communication traffic situation with a plurality of the RAID devices 10 managed by the remote management server 300 in accordance with the inquiry about the maximal amount of transmission data from the RAID device 10, further determines the maximal amount (X [Mbyte]) of transmission data, and responds to the RAID device 10 on the inquiry source. The determining processor 301b functions as a request receiving module for receiving the request for checking information of amount of log data receivable by the management server from disk array device, a determining module for determining amount of log data receivable by the management server, or a notifying module for transmitting information of the determined the amount to the disk array device.

The reception log data check processor 301c checks to see if the received log data has the miss of the log ID. When it is determined that the received log data has the miss of the log ID, the reception log data check processor 301c allows the output unit 400b in the control terminal device 400 to output the miss of the log ID and to send a notification of the output to the manager.

Further, the log ID of the received log data is compared with the log ID stored in the non-transmitted log ID storing table in the non-transmitted-log ID storing unit 302b. If the received log data has the log data of the log ID stored in the non-transmitted log ID storing table in the non-transmitted-log ID storing unit 302b, the log ID is deleted from the non-transmitted log ID storing table.

When the log-data management processor 301a recognizes that the log ID of the received log data has the non-transmitted log data, the transmitting instruction processor 301d of the non-transmitted log data outputs the log ID of the ‘non-transmitted log data’ or a fact that the log ID of the received log data has the ‘non-transmitted log data’ to the output unit 400b in the control terminal device 400. If the manager inputs an operation for prompting the transmission from the input unit 400a to the ‘non-transmitted log data’, the transmitting instruction processor 301d of the non-transmitted log data transmits an instruction for prompting the transmission of the ‘non-transmitted log data’ to the RAID device 10 on the transmission source of the log data.

The storing unit 302 includes: the reception log data storing DB 302a; the non-transmitted-log ID storing unit 302b; and the storing unit 302c of the determining table of the maximal amount of transmission data.

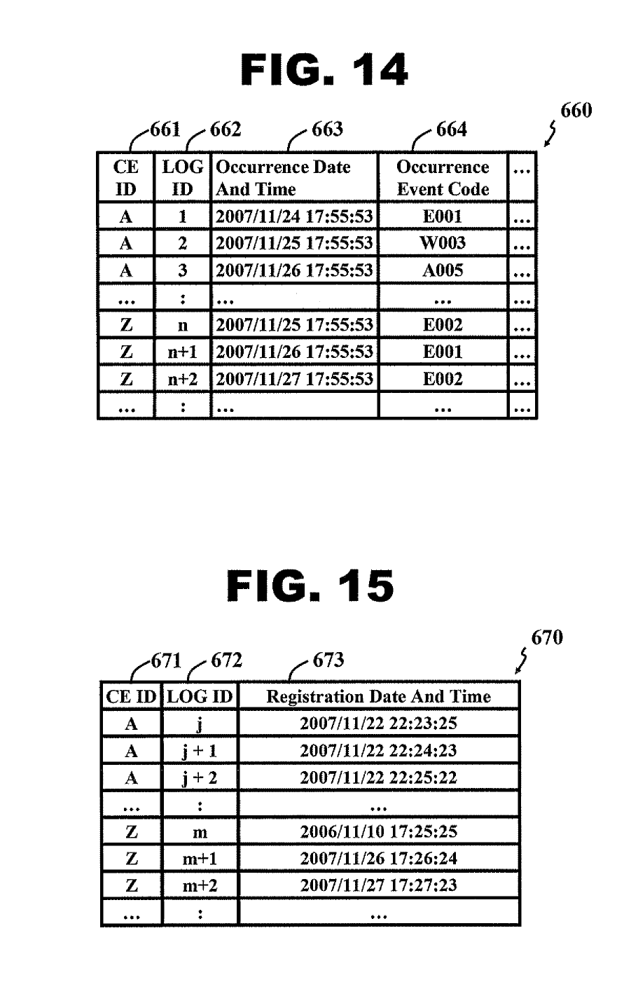

The reception log data storing DB 302a has a table 660 for storing the reception log data shown in FIG. 14. The table 660 for storing the reception log data has columns of at least ‘CE ID’ 661, ‘log ID’ 662, ‘occurrence date and time’ 663, and ‘occurrence event code’ 664.

The ‘CE ID’ 661 is identification information of the CE 100 for uniquely identifying the RAID device 10 as the transmitting source of the log data. The ‘log ID’ 662 is identification information of the log data uniquely-added for each log data every RAID device 10. The ‘occurrence date and time’ 663 indicates the date and time when the event to which the log data is written occurs in the RAID device 10. The ‘occurrence event code’ 664 is information indicating contents of the occurrence event with code.

The ‘log ID’ 662, ‘occurrence date and time’ 663 , and ‘occurrence event code’ 664 are information continuously used with the log data written by the RAID device 10 on the transmission source. Further, the ‘CE ID’ 661 is information obtained by identifying and adding the RAID device 10 on the transmission side of the log data by the log-data management processor 301a.

The non-transmitted-log ID storing unit 302b stores the non-transmitted log ID storing table 670 shown in FIG. 15. The non-transmitted log ID storing table 670 has columns of at least ‘CE ID’ 671, the ‘log ID’ 672 , and ‘registration date and time’ 673. The ‘registration date and time’ 673 indicates the date and time for registering the ‘CE ID’ 671 and ‘log ID’ 672 by the log-data management processor 301a.

The information stored in the non-transmitted log ID storing table enables the log data of which log ID in which RAID device 10 is not transmitted to be recognized. Further, upon receiving the log data later, it is determined whether or not the reception log data includes the past non-transmitted log data.

Further, the reception log data check processor 301c checks the ‘registration date and time’ 673 , thereby determining that the ‘log ID’ 672 is stored in the non-transmitted log ID storing table for a long time. Then, it is possible to detect a transmission default of the log data from the RAID device 10 to the remote management server 300.

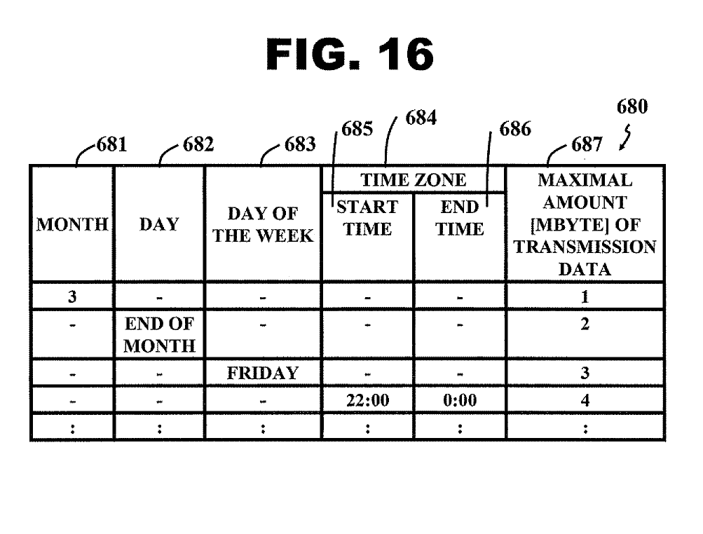

The storing unit 302c of the determining table of the maximal amount of transmission data stores a determining table 680 of the maximal amount of transmission data shown in FIG. 16. The determining table 680 of the maximal amount of transmission data has columns of at least ‘month’ 681, ‘day’ 682, ‘day of the week’ 683, ‘time zone (start time 685 and end time 686)’ 684, and ‘the maximal amount [Mbyte] of transmission data’ 687.

If at least one of “month”, “day, and “time” at the current date and time matches a storage value stored in the columns of ‘month’ 681, ‘day’ 682, and ‘time zone’ 683, ‘the maximal amount of transmission data [Mbyte]’ 687 of the matching record becomes the maximal amount (X [Mbyte]) of transmission data. The amount of the log data empirically-transmitted is expected to be large every March, every end of month, and every Friday or at 22:00 to 0:00 every day. Because the amount of the transmission log data of one RAID device 10 for one time is limited.

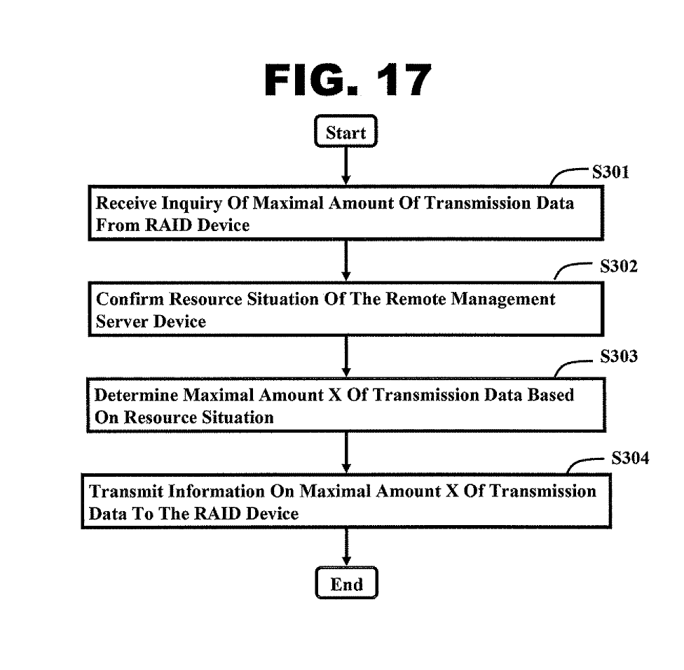

Next, a description will be given of process for transmitting the log data having the maximal amount of transmission data, executed by the remote management server 300 shown in FIG. 13. FIG. 17 is a flowchart illustrating a routine of process for transmitting the log data having the maximal amount of transmission data.

First of all, the determining processor 301b of the maximal amount of transmission data receives the inquiry (check notification) of the maximal amount of transmission data from the RAID device 10 (step S301). Subsequently, the determining processor 301b of the maximal amount of transmission data confirms the resource situation (the free capacity of the resource in the reception log data storing DB 302a in the remote management server 300, the reference result of the determining table of the maximal amount of transmission data at the current date and time in the storing unit 302c of the determining table of the maximal amount of transmission data, which will be described later, and the number of the RAID devices 10 and the communication traffic situation to a plurality of the RAID devices 10 managed by the remote management server 300) (step S302).

Subsequently, the determining processor 301b of the maximal amount of transmission data totally determines the check result of the resource situation in the remote management server 300 and thus determines the maximal amount (X [Mbyte]) of transmission data (step S303). Subsequently, the determining processor 301b of the maximal amount of transmission data transmits information on the maximal amount (X [Mbyte]) of transmission data to the RAID device 10 on the inquiry source (step S304). The process ends and the process for transmitting the information on the log data having the maximal amount of transmission data then ends.

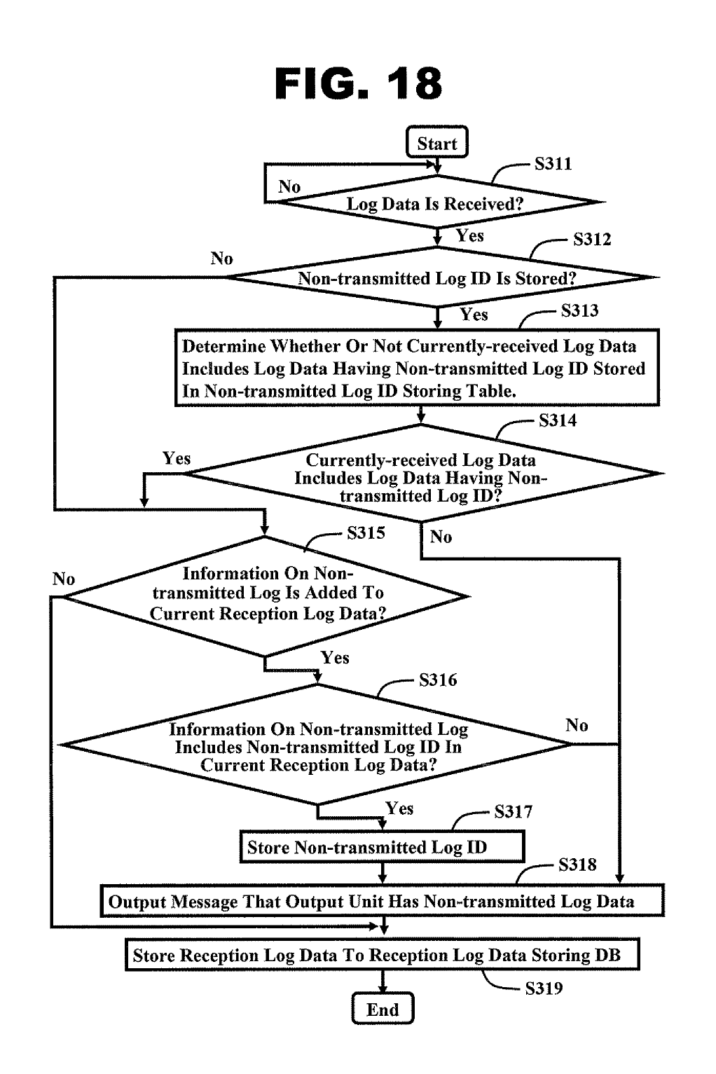

Next, a description will be given of the process upon receiving the log data executed by the remote management server 300 shown in FIG. 13. FIG. 18 is a flowchart illustrating a routine of process upon receiving the log data. The process upon receiving the log data is executed when the remote management server 300 receives the log data from the RAID device 10.

Referring to FIG. 18, the log-data management processor 301a determines whether or not the log data is received (step S311). When it is determined that the log data is received (YES in step S311), the process shifts to step S312. On the other hand, when it is not determined that the log data is received (NO in step S311), step S311 is repeated.

In step S312, the reception log data check processor 301c determines whether or not the non-transmitted log ID is stored to the non-transmitted log ID storing table in the non-transmitted-log ID storing unit 302b. When it is determined that the non-transmitted log ID is stored (YES in step S312), the process shifts to step S313. On the other hand, when it is not determined that the non-transmitted log ID is stored the non-transmitted log ID (NO in step S312), the process shifts to step S315.

In step 5313, the reception log data check processor 301c determines whether or not the currently-received log data includes the log data having the non-transmitted log ID stored in the non-transmitted log ID storing table. When it is determined that the currently-received log data includes the log data having the non-transmitted log ID (YES in step S314), the process shifts to step S315. On the other hand, when it not is determined that the currently-received log data includes the log data having the non-transmitted log ID (NO in step S314), the process shifts to step S318.

In step S315, the log-data management processor 301a determines whether or not the information on the non-transmitted log is added to the current reception log data. When it is determined that the information on the non-transmitted log is added to the current reception log data (YES in step 5315), the process shifts to step S316. On the other hand, when it is not determined that the information on the non-transmitted log is added to the current reception log data (NO in step S315), the process shifts to step 5319.

In step S316, the log-data management processor 301a determines whether or not the information on the non-transmitted log includes the non-transmitted log ID in the current reception log data (step S316). When it is determined that the information on the non-transmitted log includes the non-transmitted log ID in the current reception log data (YES in step S316), the process shifts to step S317. On the other hand, when it is not determined that the information on the non-transmitted log includes the non-transmitted log ID in the current reception log data (NO in step S316), the process shifts to step S318.

In step S317, the log-data management processor 301a stores the non-transmitted log ID included in the current reception log data to the non-transmitted log ID storing table in the non-transmitted-log ID storing unit 302b. Subsequently, the transmitting instruction processor 301d of the non-transmitted log data outputs a fact that the output unit 400b in the control terminal device 400 has the non-transmitted log data (step S318). The process ends and the routine shifts to step S319.

In step S319, the log-data management processor 301a stores the reception log data to the reception log data storing DB 302a. The process ends and the process upon receiving the log data then ends.

According to the aspect of the embodiment, if many errors in the RAID device 10 occur and the log data temporarily-written to the log disk device 103 because of the change in parts (increase/decrease in the number of disks) increases, the transmission default of the log data to the remote management server 300 can be prevented. Therefore, it is possible to prevent the shortage situation of information necessary for the error analysis of the RAID device 10 and the miss of the log data on the remote management server 300 side.

According to the aspect of the embodiment, every time when the RAID device 10 transmits the log data to the remote management server 300, the RAID device 10 inquires about the log data with the maximal amount (X [Mbyte]) of transmission data to the remote management server 300. Therefore, if resources of the reception log data storing DB 302a are expanded on the remote management server 300, dynamic tracing is possible and the log data having the maximal amount (X [Mbyte]) of transmission data can be transmitted.

The embodiments are described above. The invention is not limited to this and can be embodied within the technical essentials in Claims according to various embodiments. Further, the advantages according to the embodiment are not limited to those according to the invention.

According to the aspect of the embodiment, as shown in step S107 in the routine of process for transmitting the log data shown in FIG. 7, processing for changing the ‘priority’ of the log data transmitted to the remote management server 300 from the RAID device 10 is performed by increasing the ‘priority’ of the log data that is not transmitted because the amount of data thereof is over ‘the maximal amount (X [Mbyte]) of transmission data’ by “1” after transmitting the log data to the remote management server 300. Alternatively, as shown in step S124 in the routine of the priority determining process shown in FIG. 8, each time when the event occurs in the RAID device 10 and the log is written to the log disk device 103, the ‘priority’ of the non-transmitted log data having the matching event and ‘pattern’ is increased by “1”. The two process corresponds to ‘a plurality of priority determining logics’. However, the process for changing the ‘priority’ of the non-transmitted log data is not limited to the timings and may be properly performed for a period from the transmission time of the log data to the next transmission time of the log data.

Further, from among the process according to the aspect of the embodiment, all or a part of the process automatically-performed as mentioned above can be manually performed. Alternatively, all or a part of the process manually-performed as mentioned above can be automatically performed by a well-known method. Alternatively, the process routine, control routine, names, various data, and information including the parameters according to the aspect of the embodiment can be arbitrarily changed, except for notes.

Further, the components in the devices in the drawings are functionally conceptual, and are not necessarily physically structured in the drawings. That is, examples of disintegration and integration of the devices are not limited to those shown in the drawings, and all or a part thereof can be functionally or physically disintegrated or integrated in an arbitrary unit, depending on various loads and the using situation.

Further, all or an arbitrary part of the process functions performed by the devices is realized by a central processing unit (CPU) (or a microcomputer such as a micro processing unit (MPU) or micro controller unit (MCU)) and a program analyzed and executed by the CPU (or the microcomputer such as MPU or MCU). Alternatively, all or an arbitrary part of the process functions may be realized by hardware having a wired logic.

Accordingly the aspect of the embodiment is devised to solve the problems. It is an object of the aspect of the embodiment to provide a disk-array-device management system, a disk array device, a control method of the disk array device, and a management server in an information-processing-device management system having the management server that manages log data and an information processing device connected to the management server, in which all log data can be efficiently transmitted without fail from the information processing device to the management server.

In order to solve the problems and accomplish the object, according to a first aspect of the embodiment, in a disk-array-device management system having an management server that manages log data and a disk array device connected to the management server, the management server includes: a receiving unit that receives a check notification of a amount of log data notified from the disk array device; a determining unit of the amount of transmission that determines the amount of log data; and a notifying unit of the amount of transmission that sends a notification indicating a determining result of the determining unit of the amount of transmission to the disk array device, and the disk array device includes: a log data obtaining unit that obtains log data of the disk array device; a storing unit that stores the log data; a checking unit that checks the amount of the log data to the management server; a log information extracting unit that extracts a transmission target log on the basis of the priority of the log data determined by the check result of the checking unit and a predetermined priority determining logic; and a log data transmitting unit that transmits the extracted log data to the management server.

Further, in the disk-array-device management system according to the first aspect of the embodiment, the disk array device has a plurality of priority determining logics, and changes the priority determining logic on the basis of an event occurring in the device.

Furthermore, in the disk-array-device management system according to the first aspect of the embodiment, the disk array device determines the priority by storing the priorities determined by the priority determining logics.

In addition, in the disk-array-device management system according to the first aspect of the embodiment, the disk array device resets the priority of the log data that is not transmitted to be high.

In addition, in the disk-array-device management system according to the first aspect of the embodiment, the disk array device resets the priority of only the log data based on the same event as the event additionally-occurring in the device, from among the log data that is not transmitted.

According to a second aspect of the embodiment, a disk array device connected to an management server that manages log data, includes, a log data obtaining unit that obtains the log data of the disk array device; a storing unit that stores the log data; a checking unit that checks the amount of the log data to the management server; a log information extracting unit that extracts a transmission target log on the basis of the check result of the checking unit and the priority of the log data determined by a predetermined priority determining logic; and a log data transmitting unit that transmits the extracted log data to the management server.

According to a third aspect of the embodiment, a control method of a disk array device connected to an management server that manages log data, includes: a log data obtaining step of obtaining the log data of the disk array device; a storing step of storing the log data; a checking step of checking the amount of the log data to the management server; a log-information extracting step of extracting a transmission target log on the basis of the check result of the checking step and the priority of the log data determined by a predetermined priority determining logic; and a log data transmitting step of transmitting the extracted log data to the management server.

According to a fourth aspect of the embodiment, a management server that is connected to a disk array device and manages log data transmitted from the disk array device, includes: a receiving unit that receives a check notification of the amount of the log data notified from the disk array device; a determining unit of the amount of transmission that determines a amount of log data on the basis of a state of resources available for the management server; and a notifying unit of the amount of transmission that sends a notification indicating the determining result of the determining unit of the amount of transmission to the disk array device.

Further, according to the fourth aspect of the embodiment, a plurality of disk array devices are connected to the management server and determines the amount of log data on the basis of data transmitting states from the disk array devices.

According to the embodiment, each time when log data is transmitted from the disk array device to an management server, the disk array device checks the data amount to the management server and transmits the log data in accordance with the check result. Therefore, the disk array device transmits the log data corresponding to the data amount in order of the priority. Advantageously, the log data can be preferentially transmitted in order of more important log data.

Further, according to the embodiment, the disk array device has a plurality of priority determining logics, and the priority determining logic is changed on the basis of an event occurring in the device. Therefore, the transmission priority of log data necessary for analyzing the reason of the event is dynamically changed on the management server side and log data with high advantage for analyzing the reason at the time can be preferentially transmitted to the remote management server.

Furthermore, according to the embodiment, the disk array device stores priorities determined by the priority determining logics and determines the priority. Therefore, advantageously, the log data can be preferentially transmitted, starting from totally more important log data, with the priorities obtained by adding all the priorities determined by the priority determining logics.

In addition, according to the embodiment, the log data is preferentially transmitted, starting from non-transmitted log data. Therefore, advantageously, it is possible to prevent a state in which non-transmitted old log data keeps a non-transmitted state for a long time.

In addition, according to the embodiment, since the log data based on the same event as the event additionally occurring in the disk array device is preferentially transmitted, advantageously, the reason of an event with high emergency for solving the problem can be preferentially found out.

According to the aspect of the embodiment, advantageously, in information processing device management system having a management server that manages log data and an information processing device connected to the management server, log data can be efficiently received and transmitted without fails from the information processing device to the management server.

What is claimed is:

1. A method for controlling a disk array device connected to an management server for managing the disk array device, the disk array device having priority information indicating priority of transmission of log data on the basis of type of log data, comprising:
storing log data of the disk array device;
transmitting to the management server a request for checking indicating amount of log data receivable by the management server;
receiving from the management server information of amount of log data receivable by the management server;
selecting data from the log data on the basis of the amount of log data receivable by the management server and the priority information; and
transmitting the selected data to the management server.

2. The method according to claim 1, wherein the priority information includes a plurality of priority determining logics, the method further comprising changing the priority determining logic on the basis of an event occurring in the device.

3. The method according to claim 2, further comprising storing the priorities determined by the priority determining logics.

4. The method according to claim 3, further comprising updating the priority of the log data that is not transmitted.

5. A system for storing data, comprising:
a disk array device comprising,
a storing unit for storing priority information indicating priority of transmission on the basis of type of log data,
a obtaining module for obtaining log data of the disk array device,
a checking module for transmitting a request for checking amount of log data receivable, and
a receiving module for receiving the information indicating amount of log data receivable,
a selecting module for extracting data from the log data on the basis of the information of the amount of the log data and the priority information, and
a transmitting module for transmitting the selected data, and
an management server connected to the disk array device, for managing the disk array device, comprising
a request receiving module for receiving the request for checking amount of log data receivable by the management server from disk array device,
a determining module for determining amount of log data receivable by the management server,
a notifying module for transmitting information of the determined the amount to the disk array device, and
a log data receiving module for receiving the selected data from the disk array device.

6. The system according to claim 5, wherein the disk array device has a plurality of priority determining logics, and changes the priority determining logic on the basis of an event occurring in the disk array device.

7. The system according to claim 6, wherein the disk array device determines the priority by storing the priorities determined by the priority determining logics.

8. The system according to claim 7, wherein the disk array device resets the priority of the log data that is not transmitted to be high.

9. The system according to claim 8, wherein the disk array device resets the priority of only the log data based on the same event as the event additionally-occurring in the device, from among the log data that is not transmitted.

10. A disk array device connected to an management server for managing the disk array device, comprising:
a storing unit for storing priority information indicating priority of transmission on the basis of type of log data;
a obtaining module for obtaining log data of the disk array device;
a transmitting module for transmitting a request for checking information of the amount of the log data by the management server to the management server;
a receiving module for receiving the information of amount of log data receivable from the management server;
a selecting module for extracting data from the log data on the basis of the information of the amount of the log data by the management server and the priority information; and
a transmitting module for transmitting the selected data to the management server.

11. The disk array device according to claim 10, wherein the memory further stores a plurality of priority determining logics, further comprising a changing module for changing the priority determining logic on the basis of an event occurring in the device and determining the priority of the log data.

12. The disk array device according to claim 11, wherein the memory further stores the priorities determined by the priority determining logics and determines the priority.

13. The disk array device according to claim 12, wherein the extracting module further resets the priority of the log data that is not transmitted to be high.

14. The disk array device according to claim 13, wherein the extracting module further resets the priority of the log data based on the event additionally-occurring in the device, from among the log data that is not transmitted.

15. A management server connected to a disk array device, for managing the disk array device, comprising:
a receiving module for receiving an inquiry of the amount of log data notified from disk array device;
a determining module for determining the amount of log data on the basis of a state of resources available for the management server; and
a notifying module for transmitting information of the determined the amount of log data receivable by the management server to the disk array device.

16. The management server according to claim 15, wherein the management server connects a plurality of disk array devices, and the management server determines the amount of the log data on the basis of states of transmitting of data from the disk array devices.

17. The management server according to claim 15, wherein the management server determines the amount of the log data on the basis of the time for receiving the inquiry from the disk array device.
